(19) United States
(12) Patent Application Publication
(10) Pub. No.: US 2008/0218581 A1
(43) Pub. Date: Sep. 11, 2008

(54) Network audio/video communication system, comunication device and operation and audio/video data processing method for the same

(76) Inventor: Midas Tsai, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/714,174

(22) Filed: Mar. 6, 2007

(51) Int. Cl. H04N 7/14

(52) U.S. Cl. 348/14.04; 348/E07.078

(57) ABSTRACT

A network audio/video communication system, a communication device and operation and an audio/video data processing method for the same is disclosed. A user utilizes a remote control unit for operating communication software inside a network audio/video communication device to achieve audio/video communication anywhere via the Internet.

### BACKGROUND OF THE INVENTION

1. Field of the Invention

This invention relates to a network audio/video communication system, a communication device and operation and an audio/video data processing method for the same, and more particularly, to a network audio/video communication system, a communication device and operation and an audio/video data processing method for use between a digital TV box and an electronic device.

2. Description of the Prior Art

A digital TV box receives digital signals from a satellite, a cable or a standard broadcast to convert analog signals received by a traditional TV, and then transmits the analog signals to the TV screen for display. Therefore, the digital TV box can transmit an audio/video digital signal of the remote control to the TV at a different location. As such, the TV becomes a play medium.

Lately Internet users have been connecting to the Internet to use a number of different applications beyond those traditionally associated with the Internet such as visiting websites or sending email. Amongst these new applications Internet TV, Internet radio and Internet phone stand out as having a major impact upon the way the Internet changes traditional delivery methods of old applications. Internet phone changes the communication method between users. Internet phone uses VOIP protocol. There are Internet phone three different communication types of VOIP protocol: (1) computer to phone, (2) computer to computer and (3) phone to phone.

TW patent no. 485735 proposed a “Set top box with video on demand”. This patent discloses a set top box system with video on demand that stores analog program signals sent from cable TV stations and plays the audio/video. The system diagram is shown in FIG. 1. The system includes a first signal process device 10 coupled to the TV station for receiving the analog program signal to transform the digital program signal and compress the digital program signal to output a compressed program signal. A selection device 12 outputs a selection signal. A storage device 14 is coupled to the first signal process device 10 and the selection device 12 for storing the compressed program signal and receiving the selection signal to output a selection decompress program signal. A second signal process device 16 is coupled to the storage device 14, the first signal process device 10 and a video play device 18 for transmitting the selection decompress program signal to the video play device 18.

U.S. Pat. No. 6,966,063B1 proposed an “IEEE set top box device driver”. This patent discloses a communication function between a receiver/decoder and another video device (such as a digital image recorder with high-speed digital interface).

TW patent no. 1227987 proposed a “video phone combination with PSTN and ADSL.” This patent discloses a video phone device for providing parallel transmission with video and audio via tradition phone lines. The video phone device not only transmits audio data via PSTN but also transmits video data via ADSL. The video phone device diagram is shown in FIG. 2. The video phone device supports the PSTN system. The video phone device 20 has an analog audio transmission line and a transmitter 22 for receiving/transmitting audio signals. The transmitter 22 is connected to a control module unit 24 for controlling a PSTN circuit and a circuit signal constituted by the ADSL module unit 26. The ADSL module unit 26 receives a digital image sensor signal 28 and outputs a notice confirming a connected to a digital display 30.

TW patent no. 1226783 proposed a “Method of video communication for audio network phone.” This patent discloses a method of audio communication that is applied to audio network phones. The method lets users easily use video communication via audio network phone. The audio network phone diagram is shown in FIG. 3. The audio network phone 40 connects to a video process device 44 via a USB cable 42. The audio network phone 40 further comprises a phone control module 402 and a USB module 404. The video process device 44 further comprises a USB module 440, a video compress/decompress module 442, a control module 444, a video capture device 446, and a display device 448.

To sum up, the prior art of a set top box and a network video phone disclosed related technology as described above. However, a set top box combined with a network video phone is not disclosed within the prior art.

### SUMMARY OF THE INVENTION

To solve the above problems, it is an object of the present invention to provide a network audio/video communication system, a communication device and operation and an audio/video data processing method. The present invention uses a remote control unit to control the network audio/video communication system, device and includes an operating method that is achieved via the Internet.

The present invention proposes a network audio/video communication system, and comprises a first network audio/video communication device connected to the Internet for retrieving/transmitting a plurality of audio/video communication packets over the Internet; a second network audio/video communication device for retrieving/transmitting audio/video communication packets from the first network audio/video communication device via the Internet; and a plurality of electronic output devices for receiving audio/video communication packets transmitted from the first network audio/video communication device or the second network audio/video communication device.

The present invention further proposes a network audio/video communication device, and comprises a first memory unit having an operating system and communication software of the network audio/video communication device; a second memory unit electronically connected to the first memory unit for providing memory access space when controlling the operating system and the communication software; and an audio/video integrated processing unit electronically connected to the first memory unit and the second memory unit for separating at least one video signal and at least one audio signal of a plurality of voice packets via the communication software.

The present invention further proposes an operation method for a network audio/video communication device, comprising downloading communication software to a memory unit of a network audio/video communication device; controlling a virtual keyboard for inputting user data via a remote control device; and performing an audio/video dial-in procedure or an audio/video dial-out procedure for transmitting/receiving a plurality of video signals and a plurality of audio signals.

The present invention further proposes a processing method for a network audio/video communication device, and comprises receiving at least one audio/video communication packet transmitted from the Internet to the network audio/video communication device; performing a data segment allocation procedure in accordance with a data type of audio/video communication packet; separating at least one voice packet and at least one audio packet transmitted from the audio/video communication device via the data segment allocation procedure; performing a video virtual driving procedure and an audio virtual driving procedure for processing the video packets and the audio packets; transmitting the video packets and the audio packets after they have been processed to an audio/video encoder/decoder for an encoding/decoding process; and performing a video output driving procedure and an audio output driving procedure for outputting the audio packets and the video packets after they have been encoded/decoded to a video output device and an audio output device.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a system diagram of a set top box with video on demand according to the prior art;

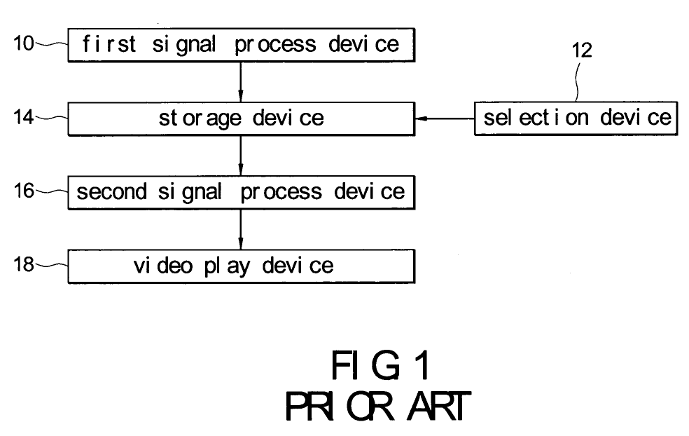

FIG. 2 is a system diagram of the video phone device according to the prior art;

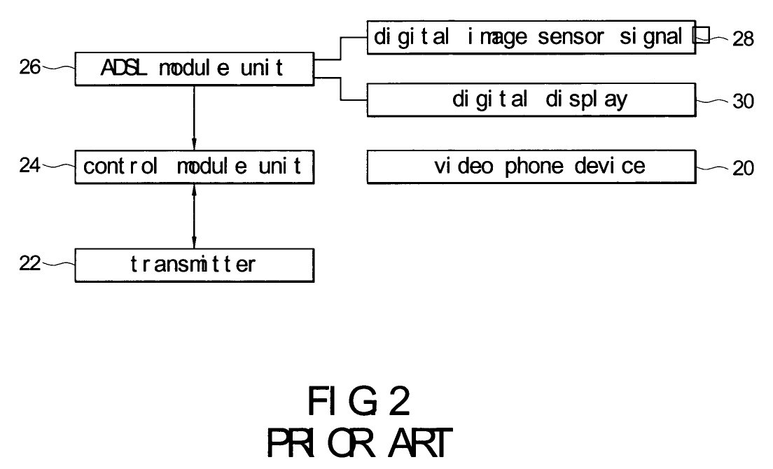

FIG. 3 is a system diagram of the audio network phone according to the prior art;

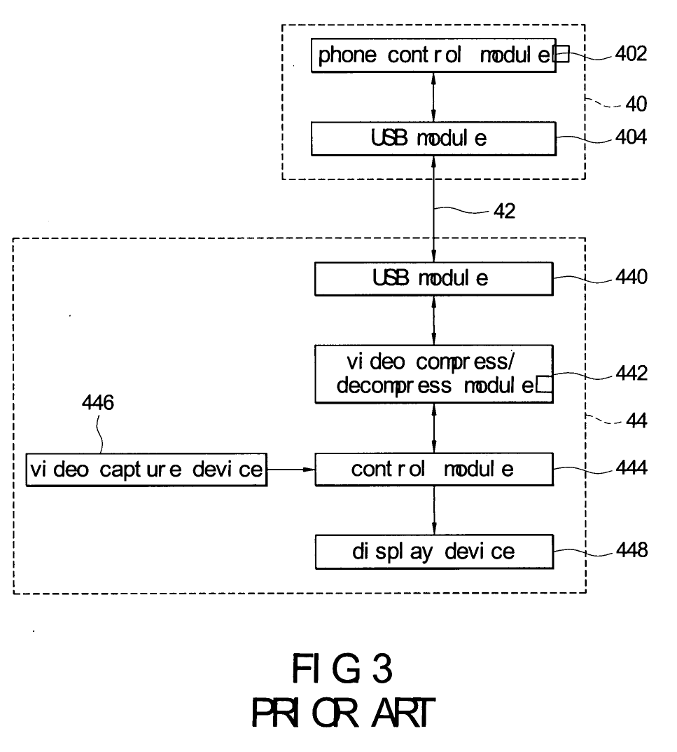

FIG. 4 is a diagram of network audio/video communication device according to the present invention;

FIG. 5 is a system diagram of the network audio/video communication according to the present invention;

FIG. 6 is a flow chart of an operating method for a network audio/video communication device according to the present invention; and

FIG. 7 is an audio/video data processing method for a network audio/video communication device according to the present invention.

### DETAILED DESCRIPTION OF THE INVENTION

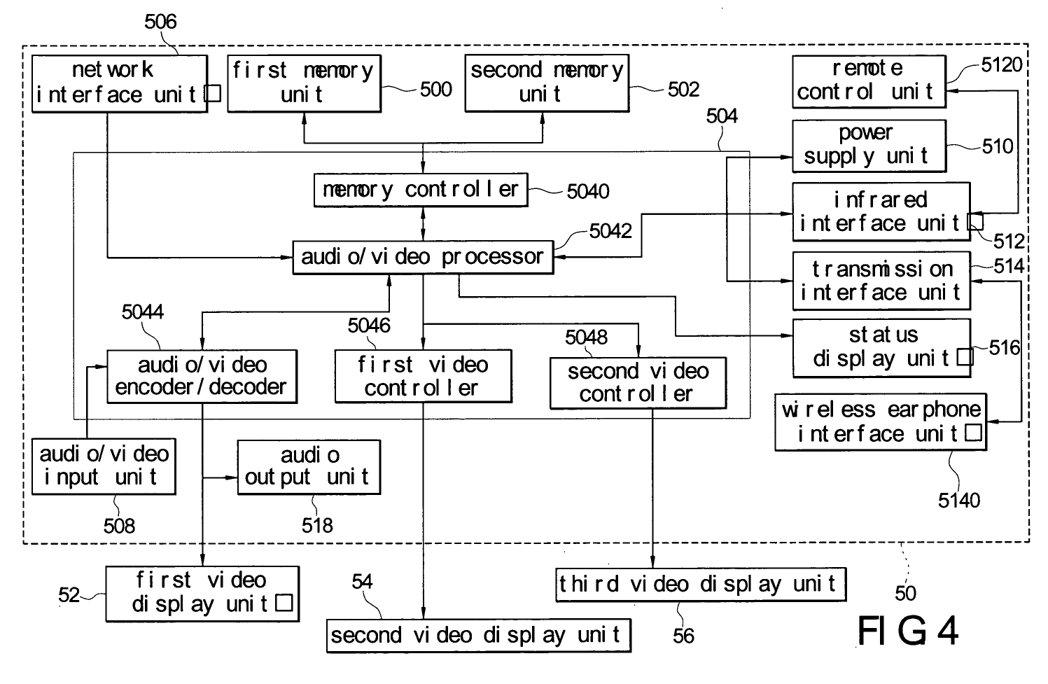

Please refer to FIG. 4 which is a diagram of network audio/video communication device of the present invention. The network audio/video communication device 50 may be a digital set top box. The network audio/video communication device 50 comprises a first memory unit 500, a second memory unit 502, an audio/video integrated processing unit 504, a network interface unit 506, an audio/video input unit 508, a power supply unit 510, an infrared interface unit 512, a transmission interface unit 514, a status display unit 516, and an audio output unit 518.

The network audio/video communication device 50 further comprises a remote control unit 5120, a wireless earphone interface unit 5140, a first video display unit 52, a second video display unit 54, and a third video display unit 56.

The inside of the audio/video integrated processing unit 504 further comprises a memory controller 5040, an audio/video processor 5042, an audio/video encoder/decoder 5044, a first video controller 5046, and a second video controller 5048.

Following is a description of the network audio/video communication device 50. The status display unit 516 may be an LED display panel or an LCD display panel for displaying the current usage status of the audio/video integrated processing unit 504. The power supply unit 510 may be an AC/DC power supply or a DC/AV power supply coupled to the audio/video integrated processing unit 504 for providing power.

The first memory unit 500 may be a storage device, such as a flash memory, a hard disk or other such storage devices. Communication software and an embedded operating system operating on the network audio/video communication device 50 is stored on the first memory unit 500. The communication software can be Skype, MSN messenger, Yahoo messenger, ICQ messenger, Google Talk, or other such kinds of communication software. The operating system is a Windows embedded system, Redhat Linux, uClinux or other such kinds of embedded systems.

The second memory unit 502 is a random access memory, such as RAM, DDR RAM or other such kinds of RAM. The second memory unit 502 is electronically connected to the first memory unit 500 for providing a memory or buffer space for the operating system and the communication software. The audio/video integrated unit 504 is a System-On-Chip (SOC). The audio/video integrated unit 504 is electronically connected to the first memory unit 500 and the second memory 502 for separating at least one audio signal and least one a video signal of a plurality of voice packets via the communication software. The memory controller 5040 inside the audio/video processing unit 504 controls the first memory unit 500 and the second memory unit 502 simultaneously. The voice packets are inputted from the network interface unit 506 or the audio/video input unit 508. The network interface unit 506 is implemented for an Ethernet interface or a wireless interface (such as IEEE 802.11a, b or g). The audio/video input unit 508 includes a video retrieving unit (such as a Web Cam) and a microphone.

The audio/video processor 5042 is a microprocessor designed by ARM Corporation, Intel Corporation, AMD Corporation, Tensilica Corporation or other such microprocessor design corporations. The memory controller 5040 processes the voice packets and a plurality of video signals and a plurality of audio signals inputted by the network interface unit 506 or the audio/video input unit 508 via the memory controller 5040. The video signals and the audio signals are transmitted to the audio/video encoder/decoder 5044 for encoding/decoding, and then transmitted to the audio/video processor 5042 for processing. The audio/video encoder/decoder 5044 has an encoder and a decoder for supporting MPEG-4, H.264 or higher specifications. The encoded/decoded video signals are transmitted to the first video display unit 52 and the audio signals are transmitted to the audio output unit 518 or the wireless earphone unit 5140 connected with the transmission interface unit 514 for outputting to a wireless earphone (such as Bluetooth) for playing audio. The transmission interface unit 514 is a universal standard bus (hereafter USB) interface. The wireless earphone has a frame packet conversion device (not shown) for converting the wireless earphone signals to USB signals. The encoded/decoded audio/video signal is transmitted to the audio/video processor 5042 for processing the signals, which then transmits the video signals to the first video controller 5046 and the second video controller 5048 in accordance with the commands of the audio/video processor 5042. The digital video signals are transmitted to the second display controller 54 and the third display controller 56 for the displaying video signals through the two controllers 54, 56 individually. The first video display unit 5046 is an LCD display control chip. The second video control unit 5048 is a VGA display control chip. The third video control unit 56 is a monitor or projector that supports digital signals.

A user uses the remote control unit (such as an infrared controller) through the infrared interface unit 512 to send an operation command to the audio/video processor 5042 for controlling the communication software and the other application software in the first memory unit 500. The audio/video processor 5042 of the audio/video integrated processing unit 504 sends a detection signal for determining the resolution of the video display units. The audio/video processor 5042 outputs video signals corresponding to the video display unit in accordance with the detection result for displaying video.

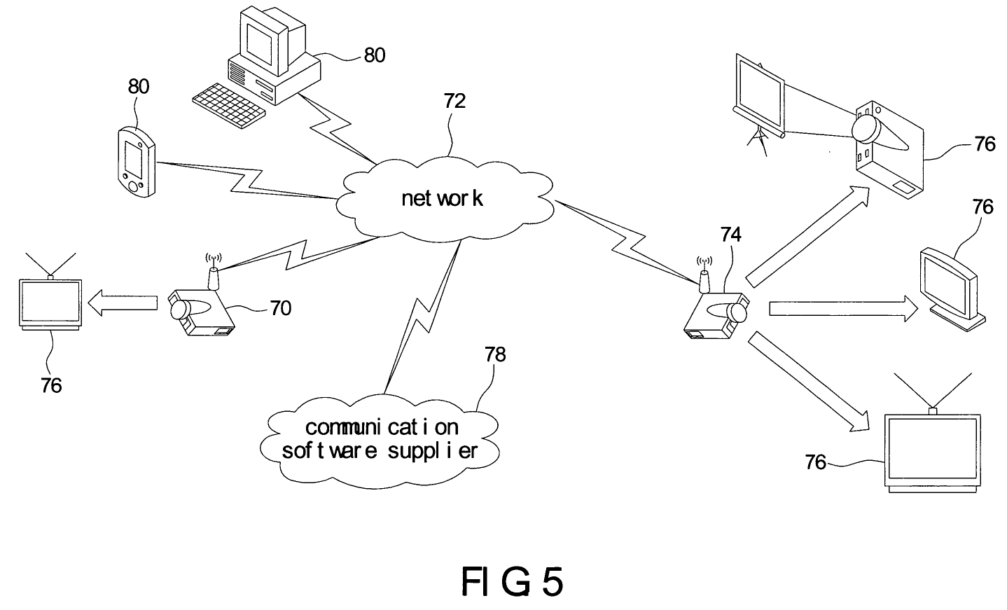

Please refer to FIG. 5 which is a diagram of the network audio/video communication system in accordance with the present invention. The system of the present invention is not limited to FIG. 5. The system includes a first network audio/video communication device 70, a network 72, a second network audio/video communication device 74, a plurality of electronic outputting devices 76, a communication software supplier 78 and a plurality of remote audio/video inputting devices 80, such as a personal computer or a handset computer.

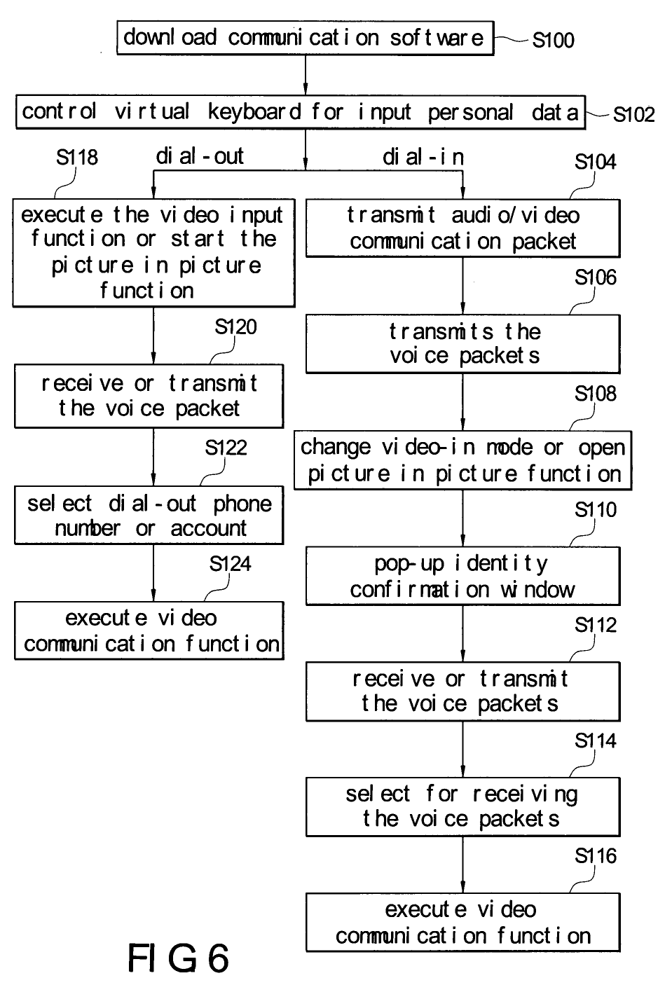

Please refer to FIGS. 4, 5 and 6. FIG. 6 is a flow chart of an operating method for a network audio/video communication device. A first user uses first network audio/video communication device 70 and a second user uses second network audio/video communication device 74. In this example the first user is a transmitter and the second user is a receiver, but the situation can be vice versa. The fist network audio/video communication device 70 and the second network audio/video communication device 74 have the same electronic components. In the description below any electronic components mentioned that are the same use the same representative symbols.

The first user or the second user uses the audio/video communication device 70 or the second network audio/video communication device 74 for connecting to the communication software supplier 70 via the Internet 72 to download the communication software (S100). The communication software is installed on the first network audio/video communication device 70 and the second audio/video communication device 74. The first network audio/video communication device 70 and the second audio/video communication device 74 must install the same kind of communication software. The first user or the second user transmits a control signal to control a virtual keyboard for inputting personal data via the remote control unit 5120 (S102).

Next, the first user executes a dial-out procedure. At least one audio/video communication packet from an external location is transmitted to the second network audio/video communication device 74 via the Internet 72 (S104). At this time, the status display unit 516 of the second network audio/video communication device 74 will turn-on/turn-off to display, for example, a flashing of images or different colors to attract the user's attention. At the same time, the audio output unit 518 will notify the second user of the voice packets transmitted to the second network audio/video communication device 74, and the second user will prepare to listen to the voice packets via the audio output unit 518 (S106). The second user changes the electronic outputting devices 76 to video-in mode or opens a picture in picture program of the electronic outputting devices 76 (S108). The electronic outputting devices may be a projector, a terminal, a digital TV, an LCD TV, a PDP TV or a traditional analog TV.

The first display unit 52, the second display unit 54 and the third display unit 56 of the electronic outputted device 76 display a pop-up window that confirms the identity of the caller's ID (S110). The second user selects the audio/video input device 508, the audio output unit 518 or a wireless earphone interface unit 5140 for receiving or transmitting voice packets (S112). The second user selects to receive voice packets via the remote control unit 5120 (S114). The communication software of the second audio/video communication device 74 drives transmission of the voice packets to the first video display unit 52, the second video display unit 54 or the third video display unit 56 for video communication (S116).

The first user opens the video input function of first video display unit 52, the second video display unit 54 and the third video display unit 56 of the first network audio/video communication device 70, or starts the picture in picture function of the video display units (S118). The first user selects the audio/video input unit 508, the audio output unit 518 or the wireless earphone interface unit 5140 to receive or transmit voice packets (S120). The first user selects a dial-out phone number or account for listening or dialing-out the voice packets via the remote control unit 5120 (S122). The communication software of the first network audio/video communication device 70 drives transmission of the voice packets to the first video display unit 52, the second video display unit 54 or the third video display unit 56 for performing video communication (S124).

The second user uses the second network audio/video communication device 74 to connect with a remote audio/video inputted device 80 without a network audio/video communication device for performing video communication. The remote audio/video inputted device 80 may be a personal computer or a handset computer and the remote audio/video imputed device 80 has communication software.

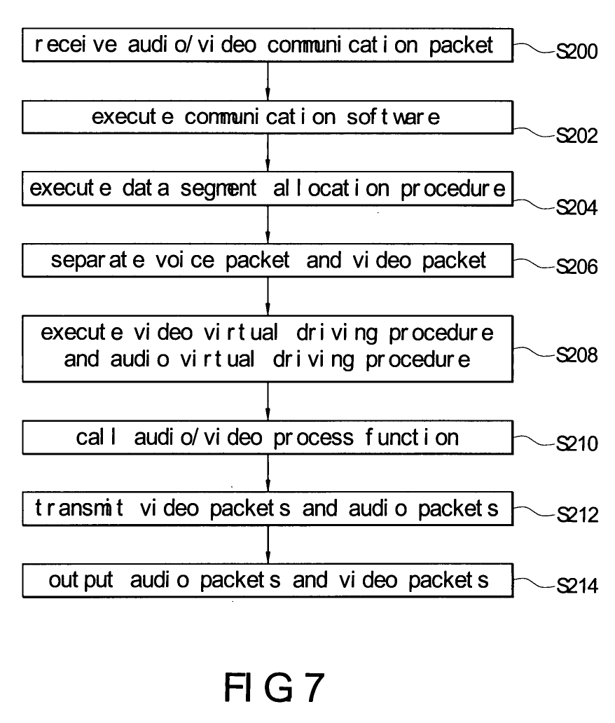

Referring to FIG. 7, an audio/video data processing method for a network audio/video communication device in accordance with the present invention is shown. The method comprises the steps of the network audio/video communication device receiving at least one audio/video communication packet via the Internet (S200). Communication software inside of a first memory unit of the network audio/video communication device is opened (S202). A data segment allocation procedure is executed in accordance with a data type of the audio/video communication packets (S204). At least one voice packet and at least one video packet of the audio/video communication packets is separated through the data segment allocation procedure (S206). A video virtual driving procedure and an audio virtual driving procedure are executed for processing the video packets and the audio packets (S208). An audio/video processing function is started to process the video packets and the audio packets outputted from the video virtual driving procedure and the audio virtual driving procedure (S210). The video packets and the audio packets are processed and transmitted to an audio/video encoder/decoder for an encoding/decoding process (S212). A video output driving procedure and an audio output driving procedure are begun and output the audio packets and the video packets after encoding/decoding to a video output device and an audio output device (S214).

Communication software is downloaded to the first memory unit of the network audio/video communication device via the communication software supplier 78. The present invention uses the video virtual driving procedure and the audio virtual driving procedure to simulate the audio/video communication packets so that they seem to be only one voice packet. The communication software recognizes the audio/video communication packets as pure voice packets. The communication software transmits the voice packets to the audio/video processor for decoding. The audio/video communication packets are returned for outputting corresponding video and audio when the voice packets have been decoded.

The user can use the network audio/video communication application via the remote control unit anywhere where there is a network audio/video communication device and audio/video output equipment that matches with the first video display unit 52, the second video display unit 54 or the third video display unit 56, and the remote control unit which controls the network audio/video communication device. The transmitting user places a call via an audio/video phone to the receiving user's phone number via the remote control unit. The receiving user can receive the transmitting user's audio/video call whether or not they have a network audio/video communication device of the present invention. The present invention solves the problems encountered when the transmitting user's and the receiving user's networks use different audio/video communication devices. There are three types of receiving users as is described below:
1. The receiving user is using the network audio/video communication device of the present invention. The transmitting user and the receiving user are both using the network audio/video communication device of the present invention, so both the transmitting user and the receiving user can use the audio/video communication device via the remote control unit.
2. The receiving user does not have the network audio/video communication device of the present invention but does have the communication software stored on an electronic device. The transmitting user encodes the audio/video packet and the audio packet into voice packets for transmission to the receiving user via the network audio/video communication device. The electronic device of the receiving user receives the voice packets. Next, determining whether the electronic device of the receiving user supports the video data or not. If yes, then the electronic device of the receiving user outputs video and audio simultaneously. Otherwise, only audio data is outputted.
3. The receiving user does not have the network audio/video communication device of the present invention and the electronic device of the receiving user does not have the communication software. The receiving user can only output audio data.

The present invention is based on the communication software and the network environment and can be applied to groups of users having non-moveable video output equipment. A user with an audio/video communication device can connect to a user having the audio/video communication device or a user having a computer but not having the audio/video communication device and still use the audio/video communication application. The receiving user only needs network equipment, a TV, a terminal or a projector to use the network audio/video communication application.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A network audio/video communication system, comprising:
a first network audio/video communication device connected to an Internet for retrieving/transmitting a plurality of audio/video communication packets to the Internet;
a second network audio/video communication device for retrieving/transmitting the audio/video communication packets from the first network audio/video communication device via the Internet; and
a plurality of electronic output devices for receiving the audio/video communication packets transmitted from the first network audio/video communication device or the second network audio/video communication device.

2. The system according to claim 1, further comprising a communication server connected to the Internet for transmitting the audio/video communication packets to a plurality of phone devices.

3. The system according to claim 2, further comprising a public service telephone network connected to the communication server and the phone devices.

4. The system according to claim 1, further comprising a plurality of remote audio/video inputted devices for performing audio/video communication with the second network audio/video communication device via the Internet.

5. The system according to claim 1, wherein the electronic output device is a projector, a terminal, a digital TV, an LCD TV, a PDP TV or a traditional analog TV.

6. The system according to claim 2, wherein the phone device is a tradition phone or a mobile phone.

7. A network audio/video communication device, comprising:
a first memory unit having an operating system and communication software of the network audio/video communication device;
a second memory unit electronically connected to the first memory unit for providing a memory access space when controlling the operating system and the communication software; and
an audio/video integrated processing unit electronically connected to the first memory unit and the second memory unit for separating at least one video signal and at least one audio signal of a plurality of the voice packets via the communication software.

8. The device according to claim 7, further comprising a network interface unit for connecting to the Internet.

9. The device according to claim 7, further comprising an audio/video input unit for inputting at least one video signal and at least one audio signal.

10. The device according to claim 7, further comprising a status display unit for displaying the current status of the audio/video integrated processing unit.

11. The device according to claim 7, further comprising a power supply unit coupled to the audio/video integrated processing unit for providing power to the audio/video integrated processing unit.

12. The device according to claim 7, further comprising an infrared interface unit for receiving infrared signals transmitted from a different location.

13. The device according to claim 12, further comprising a remote control unit for transmitting infrared signals to the infrared interface unit.

14. The device according to claim 7 further comprising a transmission interface unit for receiving a wireless signal that matches the transmission interface unit supported by the different location.

15. The device according to claim 14, further comprising a wireless earphone interface unit for transmitting wireless signals that matches the transmission interface unit.

16. The device according to claim 9, wherein the audio/video integrated processing unit further comprises:
a memory controller for controlling the first memory unit and the second memory unit;
an audio/video processor for processing voice packets and a plurality of audio signals and a plurality of voice signals inputted from the different location via the memory controller;
an audio/video encoder/decoder for encoding/decoding voice packets, the audio signals and the voice signals processed from the audio/video processor;
a first video controller for receiving the audio signals and the voice signals processed from the audio/video processor and the audio signals and the voice signals inputted from the audio/video inputted device; and
a second video controller for receiving the video signals processed from the audio/video processor and the video signals inputted from the audio/video inputted device.

17. The device according to claim 16, further comprising a first video display unit for displaying the video signals outputted from the audio/video encoder/decoder.

18. The device according to claim 16, further comprising a second video display unit for displaying the video signals outputted from the first video controller.

19. The device according to claim 16, further comprising a third video display unit for displaying the video signals outputted from the second video controller.

20. The device according to claim 16, further comprising an audio output unit for playing the audio signals outputted from the audio/video encoder/decoder.

21. An operation method for a network audio/video communication device, comprising:
downloading communication software to a memory unit of a network audio/video communication device;
controlling a virtual keyboard for inputting user data via a remote control device; and
performing an audio/video dial-in procedure or an audio/video dial-out procedure for transmitting/receiving a plurality of video signals and a plurality of audio signals.

22. The method according to claim 21, wherein the step of performing an audio/video dial-in procedure, further comprising the steps of:
providing a plurality of voice packets having at least one voice signal and at least one audio signal transmitted to the network audio/video communication device;
executing a video input function or starting a picture in picture function of a video controller of the audio/video communication device;
popping up an identity confirmation window for displaying the caller's ID;
opening an audio/video input unit, a voice output device or a wireless earphone interface unit;
receiving the voice packet; and
driving the communication software and executing a video communication function via the video controller.

23. The method according to claim 22, wherein the step of providing a plurality of voice packets, further comprising driving a status display unit and a voice output device for notifying the user regarding the voice packets transmitted to the network audio/video communication device.

24. The method according to claim 21, wherein the step of executing an audio/video dial-out procedure, further comprising the steps of:
executing a video input function or starting a picture in picture function of a video controller of the audio/video communication device;
opening the communication software for executing the audio/video dial-out procedure;
opening an audio/video input unit, a voice output device or a wireless earphone interface unit;
selecting a phone number or an account for dialing-out or listening to the voice packets; and
driving the communication software and executing a video communication function via the video controller.

25. A processing method for a network audio/video communication device, comprising the steps of:
receiving at least one audio/video communication packet transmitted from an Internet to the network audio/video communication device;
executing a data segment allocation procedure in accordance with a data type of the audio/video communication packets;
separating at least one voice packet and at least one audio packet from the audio/video communication device via the data segment allocation procedure;
executing a video virtual driving procedure and an audio virtual driving procedure for processing the video packets and the audio packets;
transmitting the video packets and the audio packets after processing to an audio/video encoder/decoder for encoding/decoding processing; and
performing a video output driving procedure and an audio output driving procedure for outputting the audio packets and the video packets after encoding/decoding to a video output device and an audio output device.

26. The method according to claim 25, wherein the communication software and an embedded operating system are stored on the first memory unit.

27. The method according to claim 25, wherein the step of executing a video virtual driving procedure further comprising calling an audio/video process function to process the video packets and the audio packets outputted from the video virtual driving procedure and the audio virtual driving procedure.
